(19) United States
(12) Patent Application Publication
(10) Pub. No.: US 2014/0029913 A1
(43) Pub. Date: Jan. 30, 2014

(54) Controlling Trick Play And Progress of Media Playback For Multiple Media Devices

(71) Applicants: Juan M. Lopez, Chicago, IL (US); Malcolm R. Dwyer, Lindenhurst, IL (US); Michael S. Thiems, Edwardsville, IL (US)

(72) Inventors: Juan M. Lopez, Chicago, IL (US); Malcolm R. Dwyer, Lindenhurst, IL (US); Michael S. Thiems, Edwardsville, IL (US)

(73) Assignee: GENERAL INSTRUMENT CORPORATION, Horsham, PA (US)

(21) Appl. No.: 13/562,274

(22) Filed: Jul. 30, 2012

(51) Int. Cl. H04N 5/765; H04N 5/783; H04N 5/775

(52) U.S. Cl. 386/230; 386/E05.002; 386/E05.07; 386/E05.052

(57) ABSTRACT

Controlling trick plays, such as play, pause, fast forward, and rewind, of a plurality of content items includes respectively assigning, via a remote-control device, a plurality of trick-play bars to the plurality of content items. The plurality of trick-play bars is operative on the remote-control device. The controlling further includes directing, via the remote-control device, a plurality of media devices to respectively play the plurality of content items. The controlling further includes displaying, on the remote-control device, the plurality of trick-play bars based on the assigning of the plurality of trick-play bars to the plurality of content items, and controlling an operation, via the remote-control device, of a trick play of one of the plurality of content items, respectively, via an input respectively received by one of the plurality of trick-play bars.

### BACKGROUND

A media system may include a number of media devices on which a number of content items may be played, and may provide useful features or controls for playback of the content items on one or more of the media devices. However, conventional features or controls may be frustrating for a user who desires to synchronize or coordinate substantially simultaneous play of content items on more than one of the media devices. Media devices that may be used in such a media system include: set-top-boxes (STBs), personal video recorders (PVRs), televisions, computing devices (e.g., personal computers, tablet computers, etc.), mobile-media devices (e.g., smartphones, personal digital assistants (PDAs), etc.), etc.

A media system might include media devices distributed, and typically networked, throughout a location, such as a home. For example, a user may have a STB in one room for playing a first content item (e.g., a movie, a television show, a music file, etc.) on a television, a second STB in another room for playing a second content item (e.g., a television program) on another television, and a tablet computer for playing a third content item (e.g., a music file). While watching each individual content item, a user may control “trick plays” of the content items playing on the media devices from a single remote-control device. Trick plays include fast forward, pause, reverse, slow motion, etc. A user may also control the audio volume, power and other properties of the devices.

A user may separately control playback of a content item playing on each media device. For example, a user may swipe or drag a conventional playhead indicator on a touch screen of a device, e.g., on a smartphone or tablet, to fast forward the content item playing on that device. Also, a user may use a remote-control device to control trick plays of each media device. However, in some cases, different remote-control devices are needed to control multiple media devices. Even if a single remote-control device is used to control multiple media devices, a user has to switch the remote-control device among control of different media devices, such as by a button that toggles control among the media devices, or by manually selecting among different software applications (apps) for controlling respective different media devices.

### BRIEF DESCRIPTION OF THE DRAWINGS

FIG. 1A depicts an example of a media system according to one embodiment.

FIG. 1B depicts a system level view of a remote-control device according to one embodiment.

FIG. 2 depicts an image of a remote-control interface displaying a set of trick-play bars according to one embodiment.

FIG. 3 depicts an image of the remote-control interface displaying a single trick-play bar according to another embodiment.

FIG. 4 depicts an image of the remote-control interface having a trick-play bar drop-down menu where the trick-play bar drop-down menu provides a set of trick-play bar select options for selecting alternative trick-play bars to display.

FIG. 5 depicts a high-level flow diagram of a method of trick-play bar operation according to one embodiment.

FIG. 6 depicts an image of the remote-control interface displaying a selected content item selected for play and a menu of media devices on which the content item may be played.

FIG. 7 depicts menus displayed in the trick-play bars where the menus are for media devices on which content items may be played.

### DETAILED DESCRIPTION

Described herein are techniques for controlling trick plays and for monitoring the progress of multiple content items respectively played on multiple playback devices. Particular embodiments generally relate to controlling trick plays and monitoring progress of video played on multiple media devices. In the following description, for purposes of explanation, numerous examples and specific details are set forth in order to provide a thorough understanding of illustrative embodiments. Particular embodiments as defined by the claims may include some or all of the features in these examples alone or in combination with other features described below, and may further include modifications and equivalents of the features and concepts described herein.

In one embodiment, a method for controlling trick plays of a plurality of content items (e.g., movies, television shows, music files, etc.) includes respectively assigning, via a remote-control device, a plurality of trick-play bars to the plurality of content items. The plurality of trick-play bars is operative on the remote-control device. The method further includes directing, via the remote-control device, a plurality of media devices to respectively play the plurality of content items. The method further includes displaying, on the remote-control device, the plurality of trick-play bars based on the remote-control device assigning the plurality of trick-play bars to the plurality of content items. The method further includes controlling an operation, via the remote-control device, of a trick play of one of the plurality of content items, respectively, via an input respectively received by one of the plurality of trick-play bars.

In another embodiment, a remote-control device for controlling trick plays of a plurality of content items includes: a processor for issuing a plurality of remote-control codes to a plurality of media devices for respectively playing the plurality of media devices, and a display coupled to the processor to display a remote-control interface. The remote-control device further includes a computer-readable storage medium, which includes instructions for controlling the processor to be operable for: respectively assigning, via the processor, a plurality of trick-play bars to the plurality of content items, wherein the plurality of trick-play bars are operative on the processor; directing, via the processor, a plurality of media devices to respectively play the plurality of content items; displaying, in the remote-control interface, the plurality of trick-play bars based on the processor assigning of the plurality of trick-play bars to the plurality of content items; and controlling an operation, via the processor, of a trick play of one of the plurality of content items, respectively, via an input respectively received by one of the plurality of trick-play bars.

In another embodiment, a non-transitory computer-readable storage medium includes stored instructions for controlling trick plays of a plurality of content items, the instructions for controlling a processor of a remote-control device to be operable for: respectively assigning a plurality of trick-play bars to the plurality of content items, wherein the plurality of trick-play bars is operative on the remote-control device; directing a plurality of media devices to respectively play the plurality of content items; displaying the plurality of trick-play bars based on the assigning of the plurality of trick-play bars to the plurality of content items; and controlling an operation of a trick play of one of the plurality of content items, respectively, via an input respectively received by one of the plurality of trick-play bars.

According to another embodiment, a device for controlling trick plays of a plurality of content items playing on a plurality of media devices includes a processor operable for receiving a plurality of remote-control codes from a remote-control device for controlling the plurality of media devices for respectively playing the plurality of content items. The remote-control device is operable for: respectively assigning a plurality of trick-play bars to the plurality of content items, displaying on a remote-control interface of the remote-control device the plurality of trick-play bars based on the assigning of the plurality of trick-play bars to the plurality of content items, and directing the processor, via at least one of the remote-control codes, to control the plurality of media device to operate a trick play of one of the plurality of content items, respectively, via an input respectively received by one of the plurality of trick-play bars. The processor is further operable for receiving the at least one of the remote-control codes from the remote-control device for controlling an operation of the trick play of the one of the plurality of content items.

According to another embodiment, a method for displaying a media-device menu for a content item on a remote-control device includes receiving policy information for the content item, wherein the policy information identifies a set of media devices on which the content item is playable, and receiving a selection for playing the content item. The method further includes displaying the media-device menu, which includes items that identify the set of media devices. The display of the media-device menu is based on the selection for playing the content item. The method further includes receiving a selection of one of the items in the media-device menu, and directing a selected media device associated with the one of the items and included in the set of media devices to play the content item.

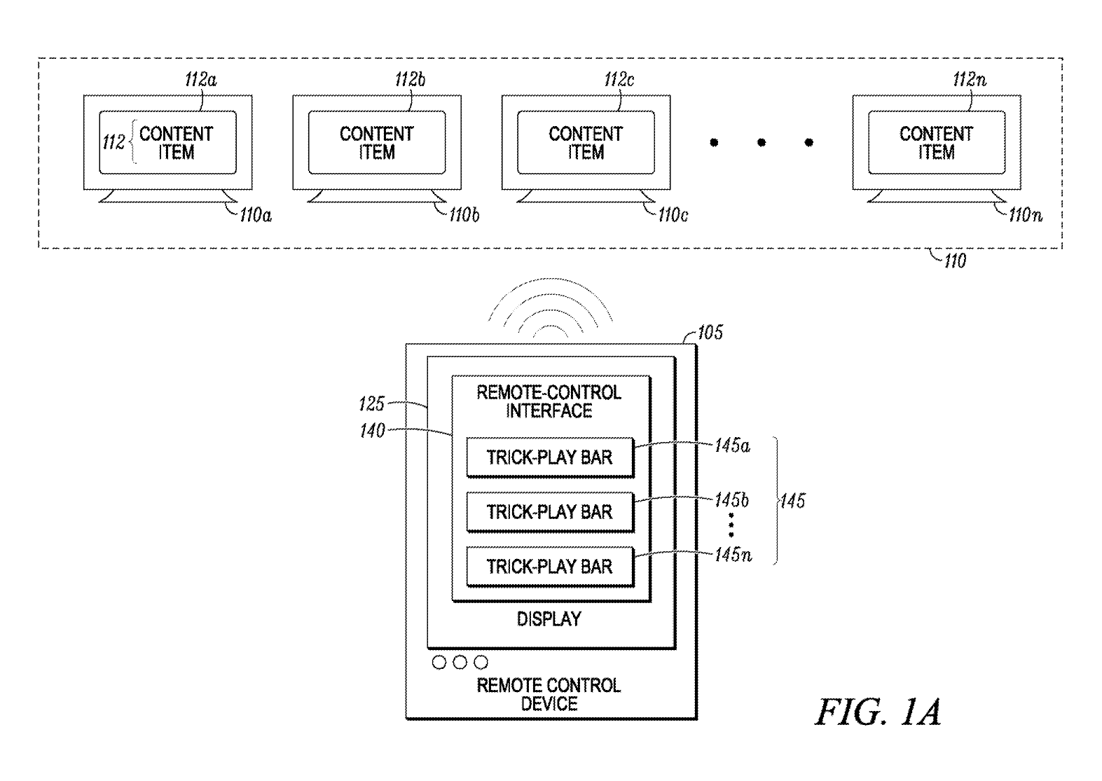

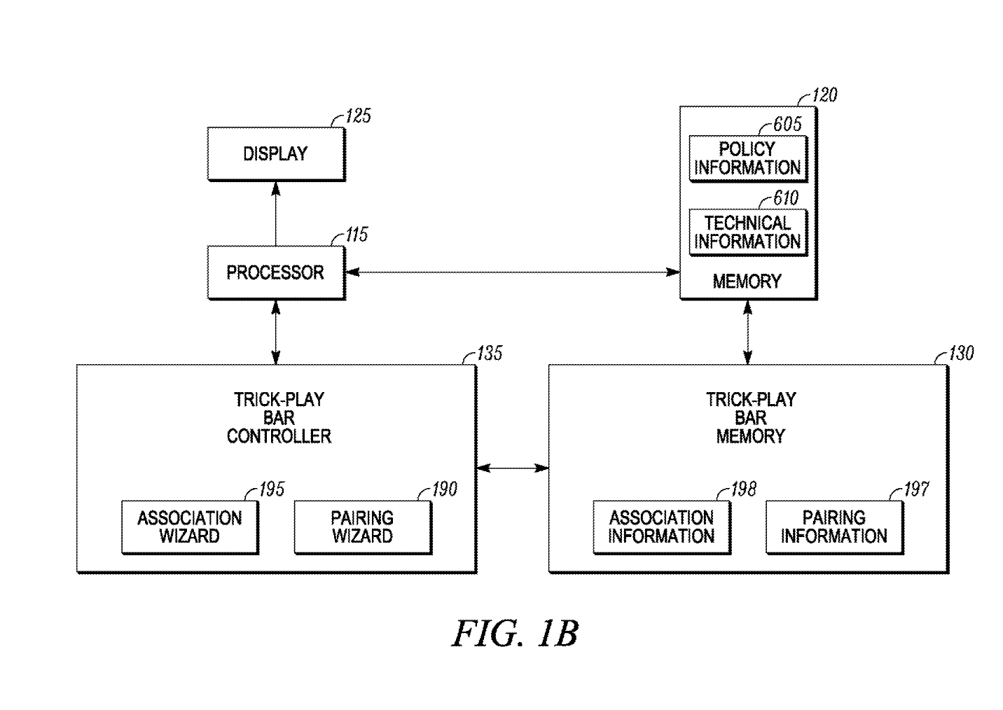

FIG. 1A depicts an example of a media system 100 that includes a remote-control device 105 and a set of media devices 110 that may be controlled by remote-control device 105 according to one embodiment. A set as referred to herein includes one or more elements. Media devices 110 are labeled in FIG. 1A with the base reference number 110 and an alphabetic suffix. Set of media devices 110 may play a set of content items 112 (labeled 112a, 112b . . . 112n in FIG. 1A), and remote-control device 105 may control the set of media devices 110 for controlling the play of the set of content items, as well as system controls such as volume and power. More specifically, remote-control device 105 may control a set of trick plays for the set of content items 112. Trick plays may include fast forward, pause, reverse, slow motion, etc. of a content item. Trick-play control is described in further detail below.

Remote-control device 105 includes a display 125, which may be a flat-panel display, such as a touch display, and may display a remote-control interface 140. Remote-control interface 140 displays a set of trick-play bars 145 (labeled 145a, 145b . . . 145n in FIG. 1A) according to one embodiment. Each trick-play bar 145a, 145b . . . 145n may be respectively associated with one of content items 112a, 112b . . . 112n and may receive a user input for controlling a trick play of one of the content items 112a, 112b . . . 112n, as well as system controls such as volume and power for the corresponding system devices (110a, 110b . . . 110n). Each trick-play bar 145a, 145b . . . 145n may receive a user input, via the display, for example, from a user's touch (tap, swipe, etc.) on the trick-play bar. Remote-control device 105, via the operation of trick-play bar 145a, 145b . . . 145n, may provide discrete control of trick plays for each content item 112a, 112b . . . 112n.

FIG. 1B depicts a system level view of remote-control device 100 according to one embodiment. FIGS. 1A and 1B are often referred to in combination. In one example, remote-control device 100 may be a separate device from media devices 110. Also, remote-control device 100 may be part of a media device 110. According to one embodiment, remote-control device 105 includes a processor 115, a computer readable storage device (memory) 120, a trick-play bar memory 130, and a trick-play bar controller 135. Processor 115 may access memory 120 to retrieve software, data, and the like for controlling display 125. Processor 115 may also operate trick-play bar controller 135 to access data in trick-play bar memory 130 for controlling trick plays. According to some embodiments, trick-play bar memory 130 may be included in memory 120.

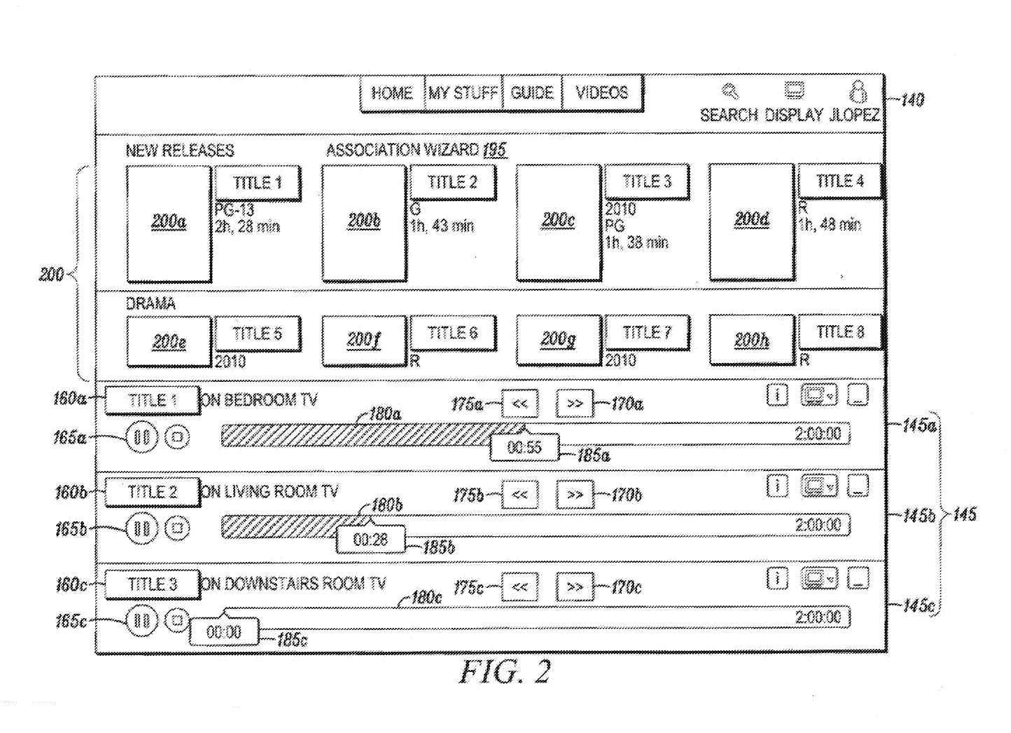

FIG. 2 depicts an image of a remote-control interface 140 displaying the set of trick-play bars 145 according to one embodiment. Specifically, FIG. 2 shows three trick-play bars 145a, 145b, and 145c according to a specific embodiment. Embodiments described herein are not limited to three trick-play bars 145. However, the following description will be directed toward the embodiment depicted in FIG. 2, where remote-control interface 140 includes the three trick-play bars 145a, 145b, and 145c.

Remote-control interface 140 may include a set of media identifiers 160 (the media identifiers are labeled 160a, 160b, and 160c in FIG. 2), which identifies the associations between content items 112a, 112b, and 112c and trick-play bars 145a, 145b, and 145c. Media identifiers 160 may include titles and other information for content items 112a, 112b, and 112c. The titles may be movie titles, television show titles, music titles, etc. Media identifiers 160 may be on trick-play bars 145a, 145b, and 145c.

Each trick-play bar 145a, 145b, and 145c may include a number of control features for controlling play of content items 112a, 112b, and 112c (e.g., trick plays of fast forward, pause, reverse, slow motion, etc.). For example, each trick-play bar 145a, 145b, and 145c may include a play-pause button (play-pause buttons are labeled 165a, 165b, and 165c in FIG. 2) for controlling play and pause of content items 112a, 112b, and 112c. Each trick-play bar 145a, 145b, and 145c may also include a fast-forward button (fast-forward buttons are labeled 170a, 170b, and 170c in FIG. 2) for fast forwarding the play of content items 112a, 112b, and 112c. Each trick-play bar 145a, 145b, and 145c may also include a reverse button (reverse buttons are labeled 175a, 175b, and 175c in FIG. 2) for reversing the play of content items 112a, 112b, and 112c. Each trick-play bar 145a, 145b, and 145c may include other buttons for controlling slow play or the like. While trick-play bars 145a, 145b, and 145c are described as including buttons for controlling play, pause, fast-forward, reverse, and slow play, trick-play bars 145 may include other screen features for controlling trick plays.

Each trick-play bar 145a, 145b, and 145c may include a progress bar (progress bars are labeled 180a, 180b, and 180c in FIG. 2) having a progress button (progress buttons are labeled 185a, 185b, and 185c in FIG. 2). Positions of progress buttons 185a, 185b, and 185c on progress bars 180a, 180b, and 180c indicate temporal positions of play of content items 112a, 112b, and 112c. Each progress button 185a, 185b, and 185c may be moved across (e.g., left or right) its associated progress bar 180a, 180b, and 180c to change the temporal positions of play of content items 112a, 112b, and 112c. According to one embodiment, progress buttons 185a, 185b, and 185c may be moved via a user input, such as touching one of the progress buttons and moving the progress button left or right.

Each trick-play bar 145a, 145b, and 145c may include buttons that control properties of the associated physical devices, such as TV volume and TV power, audio receiver volume and audio receiver power, etc.

Remote-control device 105 may control the set of media devices 110 via a variety of methods as will be well understood by those of skill in the art. For example, remote-control device 105 may control the set of media devices 110 directly or indirectly. For example, remote-control device 105 may control the set of media devices 110 directly through radio frequency (RF) communications, indirectly through a set of RF blasters, or infrared (IR) blasters, indirectly through a router (e.g., a wireless router), etc.

Remote-control device 105 may be paired to the set of media devices 110 via a variety of methods as will be understood by those of skill in the art. Referring to FIG. 1B, trick-play bar controller 135 may provide a pairing wizard 190, which a user may interact with for paring the remote-control device to the set of media devices 110. For example, pairing wizard 190 may associate each media device 110 with a trick play bar 145. According to one embodiment, trick-play bar memory 130 may store paring information 197 for the pairings.

Also, trick-play bar controller 135 may control the establishment of associations between trick-play bars 145a, 145b, and 145c and content items 112a, 112b, and 112c. Trick-play bar controller 135 includes an association wizard 195, which a user may interact with to establish the associations between trick-play bars 145a, 145b, and 145c and content items 112a, 112b, and 112c. Association wizard 195 may display a set of media icons 200 on remote-control interface 140 where the media icons identify content items 112a, 112b, and 112c. Set of media icons 200 (example media icons are labeled 200a-200h in FIG. 1) may include graphics and/or text that identify content items 112a, 112b, and 112c, for example, via title (e.g., title 1, title 2, and title 3). If one of media icons 200 is selected (e.g., via a touch selection) for playing one of the content items, association wizard 195 may assign a trick-play bar 145 to that content item 112. Trick-play bar memory 130 may store association information 198, which indicates the association between trick-play bars 145a, 145b, and 145c and content items 112a, 112b, and 112c. Thus, via the pairing information and association information 198, remote-control device 105 can control trick plays on multiple media devices 110.

According to another embodiment, the storage of pairing information (e.g., in memory 130) may exist as a network storage function wherein the paring information is stored remotely (e.g., on a remote server) in a user account rather than in remote-control device 105. According one embodiment, a user's account information for the user's account (e.g., on a remote server) includes the list of media devices that are paired, and pairing wizard 190 may also operate to store settings of the pairing wizard to the remote server. Remote-control device 115 may not have volatile memory, for example, if pairing information, pairing wizard information, etc. are stored remotely. According to one embodiment, information stored in a user's account on a remote server may be shared with a user's multiple remote-control devices (e.g., remote-control device that share access to the same account of the user), which may provide for reducing the amount of setup required for a new remote-control device.

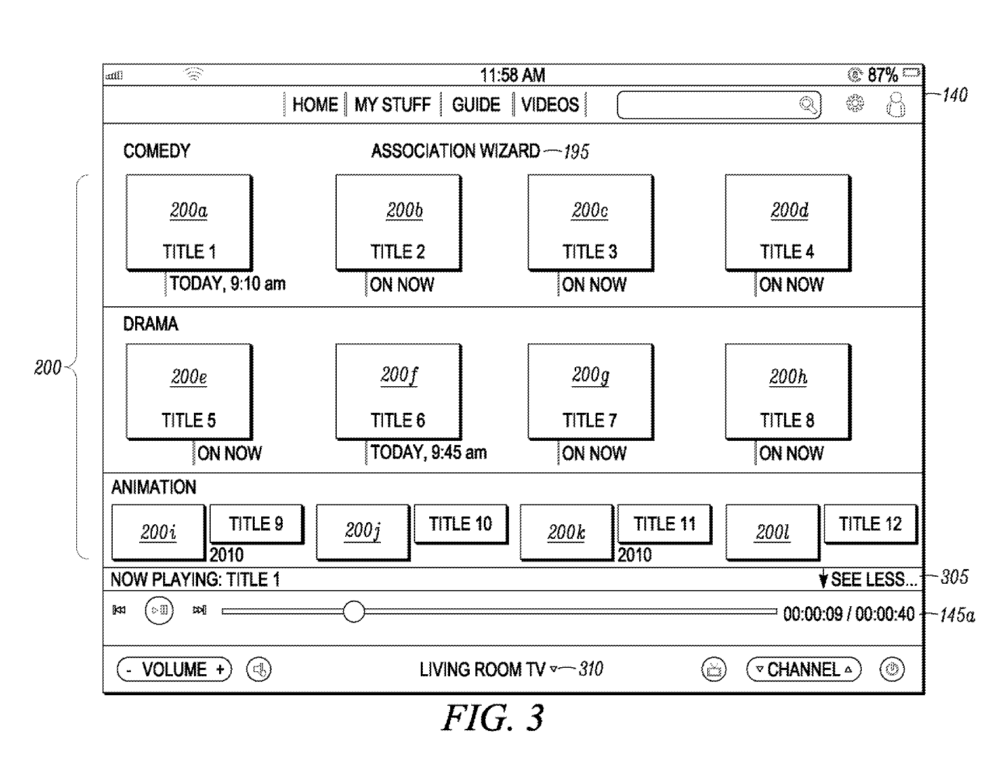

FIG. 3 depicts an image of remote-control interface 140 displaying a single trick-play bar 145a according to another embodiment. Single trick-play bar 145a may be one of many trick-play bars 145 operating on remote-control device 105 where the other trick-play bars 145 operating on the remote-control device 105 are not displayed. That is, remote-control interface 140 may display a number of trick-play bars 145 that is fewer than the number of trick-play bars that are currently operating on remote-control device 105.

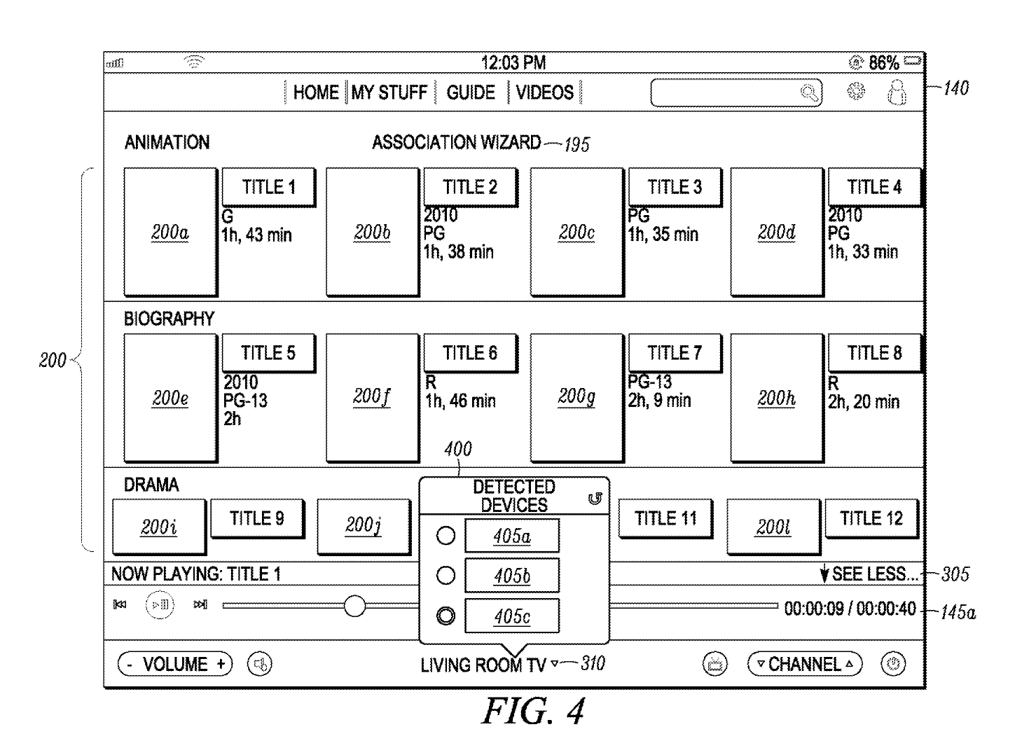

Remote-control interface 140 may include a screen button 305 or the like configured to receive a user input for reducing the number of trick-play bars displayed. Remote-control interface 140 may further include a menu button 310 or the like that provides a drop-down menu for displaying alternative trick-play bars 145. FIG. 4 depicts an image of remote-control interface 140 having a trick-play bar drop-down menu 400 providing a set of trick-play-bar select options 405 (labeled 405a, 405b, and 405c in FIG. 4) for selecting alternative trick-play bars 145 to display. Set of trick-play-bar select options 405 may include screen buttons (such as touch screen buttons) or the like. Trick-play bar drop down menu 400 may be displayed via activation of menu button 310.

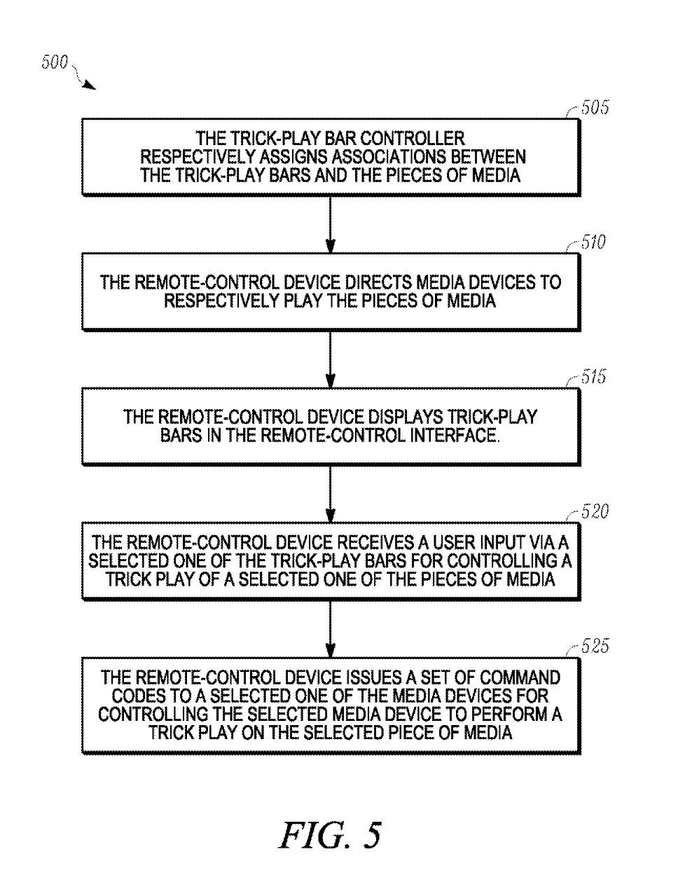

FIG. 5 depicts a high-level flow diagram of a method 500 for trick-play bar operation according to one embodiment. The high-level flow diagram is exemplary and those of skill in the art will understand that various steps of the high-level flow diagram may be combined and/or added without deviating from the scope and the purview of the embodiment.

At 505, trick-play bar controller 135 respectively assigns associations between trick-play bars 145a, 145, and 145c and content items 112a, 112b, and 112c according to one embodiment. The assignment of the associations may be initiated by trick-play bar controller 135 from user input received via association wizard 195. Association information 198 for the associations between trick-play bars 145a, 145, and 145c and content items 112a, 112b, and 112c may be stored in trick-play bar memory 130. The storage of association information 198 in trick-play bar memory 130 may be controlled by trick-play bar controller 135.

At 510, remote-control device 105 directs media devices 110a, 110b, and 110c to respectively play content items 112a, 112b, and 112c according to one embodiment. Remote-control device 105 may issue command codes to media devices 110a, 110b, and 110c to play content items 112a, 112b, and 112c via a variety of methods as described above.

At 515, remote-control device 105, displays trick-play bars 145a, 145b, and 145c in remote-control interface 140 according to one embodiment. The display of the trick-play bars 145a, 145b, and 145c may be based on trick-play bar controller 135 respectively assigning the associations between trick-play bars 145a, 145b, and 145c to content items 112a, 112b, and 112c and/or based on remote-control device 105 directing media devices 110a, 110b, and 110c to respectively play content items 112a, 112b, and 112c. As described above, trick-play bars 145a, 145b, and 145c may be displayed concurrently, in sub-sets, or individually in a sequential manner. Alternatively, the display of trick-play bars 145a, 145b, and 145c may be based on trick-play bar controller 135 searching trick-play bar memory 130 for association information 198 formed at 505 if, for example, the trick-play bars 145 are displayed sequentially.

At 520, remote-control device 105 receives a user input via a selected one of the trick-play bars 145 for controlling a trick play of a selected one of the content items 112.

At 525, remote-control device 105 issues a set of command codes to a selected one of the media devices 110 for controlling the selected media device 110 to perform a trick play on the selected content item. For example, the pairing information between trick play bar 145 and media device 110 is determined. The trick play control is then sent to the associated media device 110. Steps 520 and 525 may be repeated a number of times for the selected content item or other content items.

According to an alternative embodiment, at 510 a selected media device (e.g., media device 110a) receives the command codes from remote-control device 105 and based on the received command codes controls the other media devices (e.g., media devices 110b and 110c) to respectively play content items (e.g., content items 112b and 112c). Further, based on the user input received by the selected one of the trick-play bars at 520, the remote control device is configured to transmit command codes to the selected media device (e.g., media device 110a) for the selected media device to control one of the other media devices (e.g., media devices 110b and 110c) to execute the trick play of a selected content item (e.g., alternative to 525). The selected media device (e.g., media device 110a) may be configured to operate as a blaster device, which operates as an intermediary device between remote-control device 105 and the other media devices (e.g., media devices 110b and 110c) and transmits received command codes from remote-control device 105 to the other media devices. Remote-control device 105 may be a smartphone or the like operating a remote-control application for controlling the selected media device according to the currently described alternative embodiment or for controlling the plurality of media devices as described above with respect to the high-level flow diagram of a method 500. The selected media device (e.g., media device 110a) might be a set-top-box, a digital video recorder, or the like.

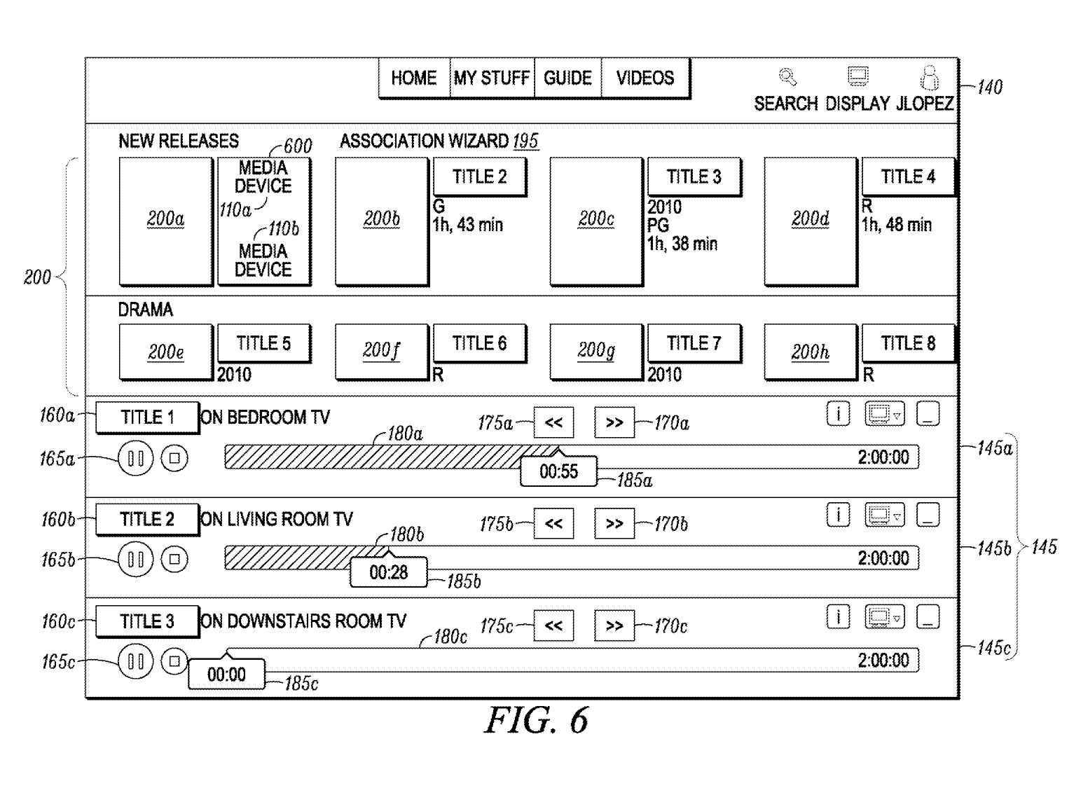

FIG. 6 depicts an image of remote-control interface 140 with a menu 600 displayed for content item 112a, which is identified by media icon 200a. According to one embodiment, after content item 112a (or any other content item 112) is selected for play, remote-control interface 140 displays menu 600 where menu 600 includes items that identify media devices 110 on which content item 112a may be played. Menu 600 may identify one or more media devices 110. Menu 600 identifies media device 110a and media device 110b, for example, on which content item 112a may be played. While the foregoing describes the display of menu 600 for content item 112a, menu 600 may be displayed for each content item 112 that is selected for play.

According to one embodiment, each content item 112 is associated with policy information 605 (see FIG. 1B) where policy information 605 identifies particular media devices 110 on which each content item 112 may be played. For example, policy information 605 may indicate that content item 112a may be played on media devices 110a and 110b, content item 112b may be played on media devices 110a and 110c, content item 112c may be played on media devices 110a, 110c, and 110n, etc. Policy information 605 may be supplied to remote-control device 105 from a variety of sources. For example, a content provider (e.g., a cable television company, a satellite television company, a network content provider, etc.) may provide policy information 605 to remote-control device 105. Policy information 605 may be provided from a content provider to remote-control device 105 via a home network or the like, which remote-control device 105 is a member. Policy information 605 may be embedded in a content item and may be provided to remote-control device 105 before the content item is played and may be stored in memory 120.

If a content item is selected for play, processor 115 may access policy information 605 and display menu 600 for the content item. A selected media device 110 identified in menu 600 may be selected for playing a content item. Each item in menu 600 may operate as a play button for the content item, and may operate as a play button for playing the content item on the particular media device identified by the item. After a selected media device 110 is selected from menu 600, remote-control device 105 directs the selected media device to play the content item.

Each content item 112 may be associated with individual policy information 605, which identifies media devices 110 on which the content item may be played. Alternatively, a group of content items 112 may be associated with policy information 605 that applies to all of the content items in the group. The group of content items 112 may be associated with a single content provider, such as a selected cable television company, a selected satellite television company, a selected network content provider, etc.

According to another embodiment, content items 112 may be playable on selected media devices 110, but might not be playable on others of the media devices for technical reasons. Technical data 610 may also be stored in memory 120 where the technical data identifies the particular media device 110 each content item 112 may be played on. If content item 112a, for example, is selected for play, processor 115 may access technical data 610 to determine media devices 110 for putting in menu 600. According to one embodiment, processor 115 may use one or both of policy information 605 and technical data 610 to determine which media devices to identify in menu 600. If processor 115 uses both policy information 605 and technical data 610 to determine menu 600, processor may generate menu 600 for media devices that exist in both policy information 605 and technical data 610. If a selected media item 110 does not exists in both policy information 605 and technical data 610 for a selected content item, then processor will not generate menu 600 to include the selected media item.

According to another embodiment, menus 600 may be, respectively, displayed for trick-play bars 145. Each trick-play bar 145 may include a screen item (e.g., a screen button) that may be selected by a user for displaying menu 600 for the trick-play bar. For example, menus 600 may be drop down menus.

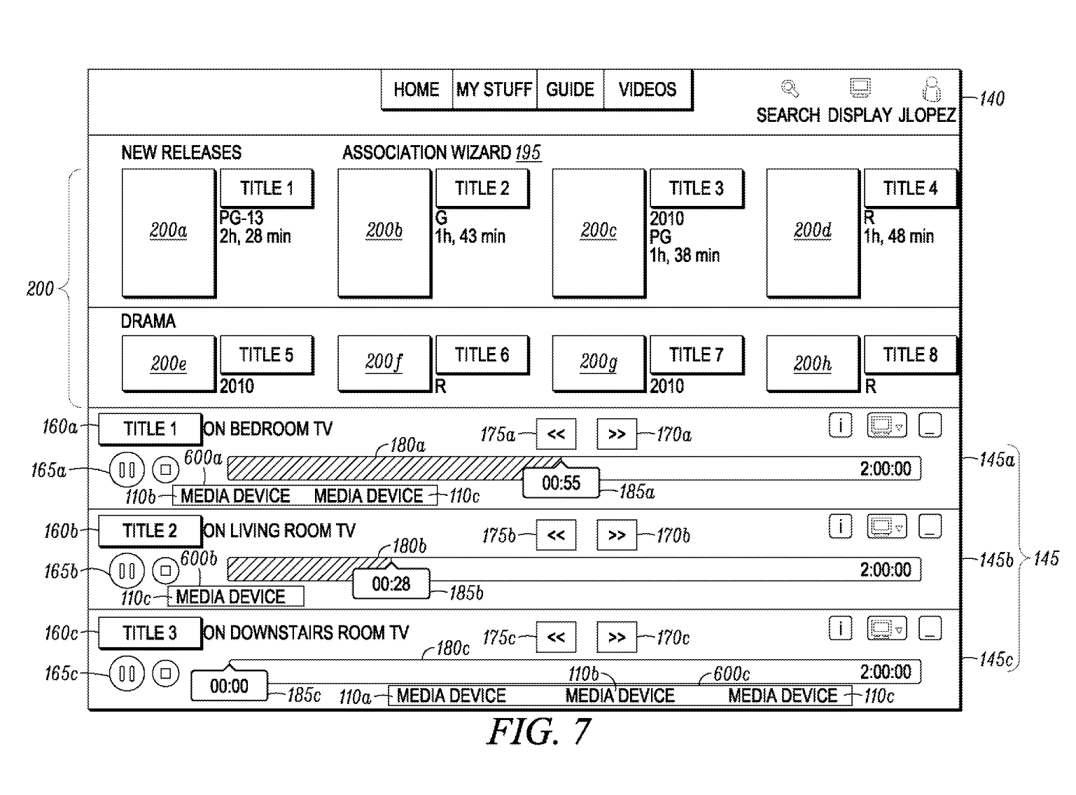

According to an alternative embodiment, menus 600 are displayed substantially the entire time that trick-play bars 145 are displayed. FIG. 7 depicts menus 600a, 600b, and 600c displayed as banners for trick-play bars 145a, 145b, and 145c. Each media device 110 identified in menu 600 for a selected trick-play bar 145 may be a media device to which the content item for the selected trick-play bar 145 may be transferred for play. For example, if a content item is playing on media device 110a in a bedroom, menu 600a for trick-play bar 145a may identify media device 110b (e.g., in a kitchen) and media device 110c (e.g., in a family room) where the content item may be transferred to play on media device 110b or media device 110c if either of these media devices is selected from menu 600a.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments, along with examples of how aspects thereof may be implemented. The above examples and embodiments should not be deemed to be the only embodiments, and are presented to illustrate the flexibility and advantages of the teachings hereof. Based on the above disclosure and the following claims, other arrangements, embodiments, implementations, and equivalents may be employed without departing from the scope hereof, as defined by the claims.

We claim:

1. A method for controlling trick plays of a plurality of content items, the method comprising:
respectively assigning, via a remote-control device, a plurality of trick-play bars to the plurality of content items, wherein the plurality of trick-play bars are operative on the remote-control device;
directing, via the remote-control device, a plurality of media devices to respectively play the plurality of content items;
displaying, on the remote-control device, the plurality of trick-play bars based on the assigning of the plurality of trick-play bars to the plurality of content items; and
controlling an operation, via the remote-control device, of a trick play of one of the plurality of content items, respectively, via an input respectively received by one of the plurality of trick-play bars.

2. The method of claim 1, wherein at least one trick-play bar in the plurality of trick-play bars includes a volume control button for controlling a volume of a device playing one of the content items included in the plurality of content items, and includes a power control buttons for powering on and powering off the device.

3. The method of claim 1, wherein displaying comprises concurrently displaying the plurality of trick-play bars on the remote-control device.

4. The method of claim 1, wherein displaying of the plurality of trick-play bars comprises:
displaying one of the plurality of trick-play bars for one of the plurality of content items assigned to the one of the plurality of trick-play bars; and
not displaying others of the plurality of trick-play bars or others of the plurality of content items.

5. The method of claim 4, further comprising displaying a button for launching a display of one of the others of the plurality of trick-play bars.

6. The method of claim 1, further comprising searching a trick-play bar memory, via a trick-play bar controller, for each of the plurality of trick-play bars associated with each of the plurality of content items for the displaying of the plurality of trick-play bars on a display of the remote-control device.

7. The method of claim 1, further comprising:
storing pairing information between the plurality of trick-play bars and the plurality of media devices; and
determining, based on the input, which of the plurality of media devices is to be controlled for the step of controlling the operation, using the stored pairing information.

8. The method of claim 7, wherein using the stored pairing information comprises:
based upon pairing information for the one of the plurality of trick-play bars, selecting one of the plurality of media devices playing the one of the plurality of content items for controlling the operation.

9. The method of claim 7, wherein storing the pairing information includes storing the pairing information in a server remote from the remote-control device.

10. The method of claim 1, wherein the plurality of trick-play bars are operable for receiving the input from a user to control fast forward, pause, rewind, and slow motion.

11. The method of claim 1, further comprising displaying a menu for at least one of the plurality of trick-play bars for at least one of the content items, wherein the menu identifies alternative media devices on which the at least one of the content items may be played, and the alternative media devices are identified in policy information for the at least one of the content items.

12. A remote-control device for controlling trick plays of a plurality of content items, the remote-control device comprising:
a processor configured for issuing a plurality of remote-control codes to a plurality of media devices for respectively playing the plurality of content items;
a display coupled to the processor for displaying a remote-control interface;
a non-transitory computer-readable storage medium comprising stored instructions for controlling the processor to be operable for:
respectively assigning, via the processor, a plurality of trick-play bars to the plurality of content items, wherein the plurality of trick-play bars are operative on the processor;
directing, via the processor, the plurality of media devices to respectively play the plurality of content items;
displaying, in the remote-control interface, the plurality of trick-play bars based on the assigning of the plurality of trick-play bars to the plurality of content items; and
controlling an operation, via the processor, of a trick play of one of the plurality of content items, respectively, via an input respectively received by one of the plurality of trick-play bars.

13. The remote-control device of claim 12, wherein at least one trick-play bar in the plurality of trick-play bars includes a volume control button for controlling a volume of a device playing one of the content items included in the plurality of content items, and includes a power control buttons for powering on and powering off the device.

14. The remote-control device of claim 12, wherein displaying comprises concurrently displaying the plurality of trick-play bars on the remote-control device.

15. The remote-control device of claim 12, wherein displaying of the plurality of trick-play bars comprises:
displaying one of the plurality of trick-play bars for one of the plurality of content items assigned to the one of the plurality of trick-play bars; and
not displaying others of the plurality of trick-play bars or others of the plurality of content items.

16. The remote-control device of claim 15, the stored instructions further comprising instructions for controlling the processor to be operable for displaying a button for launching the display of one of the others of the plurality of trick-play bars.

17. The remote-control device of claim 12, the stored instructions further comprising instructions for controlling the processor to be operable for searching a trick-play bar memory, via a trick-play bar controller, for each of the plurality of trick-play bars associated with each of the plurality of content items for the displaying of the plurality of trick-play bars on the display of the remote-control device.

18. The remote-control device of claim 12, the stored instructions further comprising instructions for:
storing pairing information between the plurality of trick-play bars and the plurality of media devices; and
determining, based on the input, which of the plurality of media devices is to be controlled for the step of controlling the operation, using the stored pairing information.

19. The remote-control device of claim 18, wherein using the stored pairing information comprises:
based upon pairing information for the one of the plurality of trick-play bars, selecting one of the plurality of media devices playing the one of the plurality of content items for controlling the operation.

20. The remote-control device of claim 18, wherein storing the pairing information includes storing the pairing information in a server remote from the remote-control device.

21. The remote-control device of claim 12, wherein the plurality of trick-play bars are operable for receiving the input from a user to control fast forward, pause, rewind, and slow motion.

22. A non-transitory computer-readable storage medium comprising stored instructions for controlling trick plays of a plurality of content items, the stored instructions for controlling a processor of a remote-control device to be operable for:
respectively assigning a plurality of trick-play bars to the plurality of content items, wherein the plurality of trick-play bars are operative on the remote-control device;
directing a plurality of media devices to respectively play the plurality of content items;
displaying the plurality of trick-play bars based on the assigning of the plurality of trick-play bars to the plurality of content items; and
controlling an operation of a trick play of one of the plurality of content items, respectively, via an input respectively received by one of the plurality of trick-play bars.

23. A device for controlling trick plays of a plurality of content items playing on a plurality of media devices, the device comprising:
a processor operable for receiving a plurality of remote-control codes from a remote-control device for controlling the plurality of media devices for respectively playing the plurality of content items, wherein the remote-control device is operable for:
respectively assigning a plurality of trick-play bars to the plurality of content items,
displaying on a remote-control interface of the remote-control device the plurality of trick-play bars based on the assigning of the plurality of trick-play bars to the plurality of content items, and
directing the processor, via at least one of the plurality of remote-control codes, to control the plurality of media devices to operate a trick play of one of the plurality of content items, respectively, via an input respectively received by one of the plurality of trick-play bars, and
wherein the processor is further operable for receiving the at least one of the plurality of remote-control codes from the remote-control device for controlling an operation of the trick play of the one of the plurality of content items.

24. The device of claim 23, wherein the remote-control device is a smartphone operable for operating a remote-control application.

25. The device of claim 23, wherein displaying comprises:
concurrently displaying the plurality of trick-play bars on the remote-control device, or
displaying one of the plurality of trick-play bars for one of the plurality of content items assigned to the one of the plurality of trick-play bars and thereafter displaying another of the plurality of trick-play bars for another of the plurality of content items.

26. A method for displaying a media-device menu for a content item on a remote-control device, the method comprising:
receiving information for the content item, wherein the information identifies a set of media devices on which the content item is playable;
receiving a first selection for playing the content item;
based on the first selection, displaying the media-device menu, which includes items that identify the set of media devices;
receiving a second selection of one of the items in the media-device menu;
directing a selected media device associated with the one of the items and included in the set of media devices to play the content item.

27. The method of claim 26, wherein displaying the media-device menu includes displaying the media-device menu with a trick-play bar for the content item.

28. The method of claim 26, wherein the information includes policy information or technical information.

29. The method of claim 28, further comprising receiving the policy information at the remote-control device from a content provider of the content item.
